(19) United States
(12) Patent Application Publication
(10) Pub. No.: US 2025/0307851 A1
(43) Pub. Date: Oct. 2, 2025

(54) A METHOD OF MANAGING CONTRACTS WITH SUPPLIERS OF PRODUCTS

(71) Applicant: Dell Products L.P., Round Rock, TX (US)

(72) Inventors: LEV MAKLER, Be'er Sheva (IL); OFIR EZRIELEV, Be'er Sheva (IL); ANAT PARUSH TZUR, Tel Aviv (IL); AMIHAI SAVIR, Newton, MA (US)

(21) Appl. No.: 18/622,027

(22) Filed: Mar. 29, 2024

(51) Int. Cl. G06Q 30/0202; G06Q 50/18

(52) U.S. Cl. CPC G06Q 30/0202; G06Q 50/188

(57) ABSTRACT

Methods and systems for managing contracts are disclosed. To manage contracts with suppliers of products, an aggregated demand prediction may be obtained using a set of demand predictions generated by a first inference model. The aggregated demand prediction may then be compared to an aggregated supply prediction, the aggregated supply prediction being based on a set of supply predictions generated by a second inference model to obtain a difference. A determination may then be made using at least a portion of the difference and acceptability criteria regarding whether the difference is deemed to be acceptable based on the acceptability criteria. If it is determined the difference is not acceptable, the addition of an options clause to the contract may be recommended, and may indicate a quantity of products to be provided by the supplier when the options clause is exercised.

### FIELD

Embodiments disclosed herein relate generally to contract management. More particularly, embodiments disclosed herein relate to systems and methods to manage contracts with suppliers of products.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIG. 3 shows a flow diagram illustrating methods of managing contract recommendations in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing contracts. To manage contracts, a first inference model may be used to generate demand predictions for products over a duration of time using demand data. The demand predictions may then be aggregated to form an aggregated demand prediction.

The aggregated demand prediction may then be compared to an aggregated supply prediction. To obtain the aggregated supply prediction, a second inference model may be used to generate supply predictions for the products over a duration of time using supply data. By comparing the aggregated demand prediction to the aggregated supply prediction, a difference may be obtained. The difference may indicate a quantity of the products needed for product supply to meet product demand, as well as a level of uncertainty in the quantity of the products needed for product supply to meet product demand.

The difference may then be used to generate a contract recommendation. To generate the contract recommendation, the difference may be compared to acceptability criteria. If the difference is deemed acceptable (e.g., meets the acceptability criteria), the addition of an options clause to the contract may not be recommended. If the difference is deemed unacceptable, the addition of an options clause to the contract may be recommended.

The recommended options clause may include an option to purchase a quantity of the products needed to hedge against the uncertainty to reduce a likelihood of the product supply not meeting the product demand. Additionally, the global recommendation indicating the total quantity of products to be added to the contracts with all the suppliers may be considered to optimize the overall product cost.

Thus, embodiments disclosed herein may address, among other technical problems, the technical challenge of determining whether to add an options clause to a contract with a supplier of products and the quantity of the products to include in the options clause. By generating aggregated supply predictions and aggregated demand predictions using inference models, total supply and total demand for a product may be used to determine whether supply is predicted to meet demand. Additionally, the difference between the aggregated supply and aggregated demand predictions may quantitatively indicate how many products may be needed for supply to meet demand. The uncertainty in the difference may be used to ensure a sufficient quantity of products are added to the options clause (e.g., to meet a risk tolerance of the entity obtaining the products from the supplier) by adding the quantity of products indicated by the uncertainty value to the contract.

In an embodiment, a method for managing contracts is disclosed. The method may include: obtaining, using a set of demand predictions generated by a first inference model, an aggregated demand prediction, the aggregated demand prediction being intended to predict demand for products over a duration of time; comparing the aggregated demand prediction to an aggregated supply prediction, the aggregated supply prediction being based on a set of supply predictions generated by a second inference model and being intended to predict supply of the products over the duration of time to obtain a difference; making a determination, using at least a portion of the difference and acceptability criteria, regarding whether the difference is deemed to be acceptable based on the acceptability criteria; in a first instance of the determination in which the difference is not deemed to be acceptable based on the acceptability criteria: recommending addition of an options clause to a contract of the contracts with a supplier of the products, the options clause indicating a quantity of the products to be provided by the supplier when the options clause is exercised; and in a second instance of the determination in which the difference is deemed to be acceptable based on the acceptability criteria: recommending completion of the contract without the addition of the options clause.

Obtaining the aggregated demand prediction may include: obtaining demand data; obtaining, using the first inference model and the demand data, the set of demand predictions; and aggregating the set of demand predictions to obtain the aggregated demand prediction.

The set of demand predictions may be stored as a list that specifies internal consumers and sub-demand for each of the internal consumers, and the aggregate demand prediction may include: a sum of the sub-demand for each of the internal consumers; and a level of uncertainty in the sum of the sub-demand for each of the internal consumers.

Obtaining the aggregated supply prediction may include: obtaining supply data; obtaining, using the second inference model and the supply data, the set of supply predictions; and aggregating the set of supply predictions to obtain the aggregated supply prediction.

The difference may include a quantity of products needed for product supply to meet product demand over the duration of time; and a level of uncertainty in the quantity of products needed for the supply of the product to meet the demand for the product over the duration of time.

The options clause may include a quantity of products. The quantity may include: the quantity of products needed to hedge against the uncertainty to reduce a likelihood of the quantity of products not meeting the product demand.

The method may also include in the first instance of the determination in which the difference is deemed to be acceptable based on the acceptability criteria and prior to making the recommendation for addition of the options clause: generating the options clause using a rule set for options clause generation.

The rule set for options clause generation may include rules keyed to the level of the uncertainty in the quantity of the products needed for the supply of the product to meet the demand for the product over the duration of time.

The first inference model may be a neural network trained using first training data to predict product demand, and the second inference model is a neural network trained using second training data to predict product supply.

The set of supply predictions may be stored as a list that specifies suppliers and sub-supply for each of the suppliers, and the aggregated supply prediction may include: a sum of the sub-supply for each of the suppliers; and a level of uncertainty in the sum of the sub-supply for each of the suppliers.

The demand data may include at least one type of data selected from a group consisting of: historical data regarding demand for the products; and historical data regarding consumer spending.

The supply data may include at least one type of data selected from a group consisting of: historical data regarding market availability of the products; historical data regarding supply of the product from a supplier of the suppliers; and historical data regarding a likelihood of contract fulfillment by a supplier of the suppliers.

An increase in the level of uncertainty in the quantity of products needed for the supply of the product to meet the demand for the product may indicate an increase in a probability that a quantity of the products provided by the supplier according to the contract will not be sufficient to allow product supply to meet product demand.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

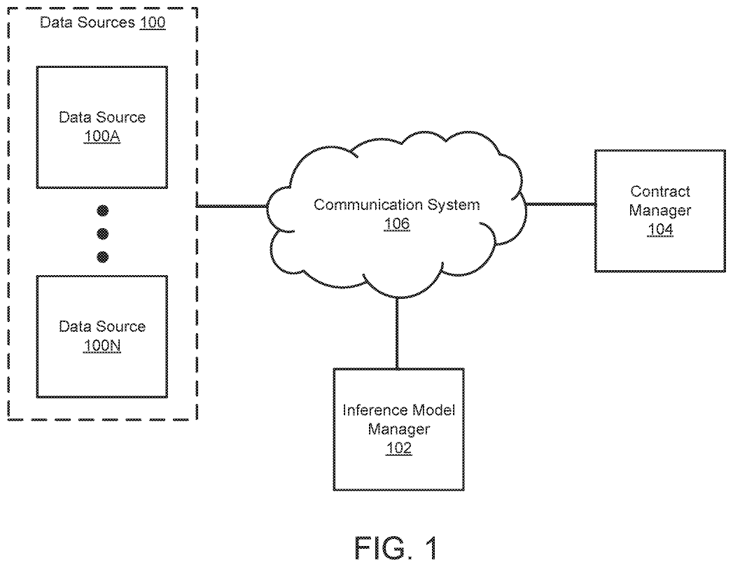

Turning to FIG. 1, a block diagram illustrating a system in accordance with an embodiment is shown. The system shown in FIG. 1 may provide computer-implemented services utilizing data obtained from any number of data sources and stored in a data repository prior to performing the computer-implemented services. The computer-implemented services may include any type and quantity of computer-implemented services. For example, the computer-implemented services may include contract managing services and/or any other type of computer-implemented services.

To provide the computer-implemented services, the system may include data sources 100. Data sources 100 may include any number of data sources. For example, data sources 100 may include one data source (e.g., data source 100A) or multiple data sources (e.g., 100A-100N). Each data source of data sources 100 may include hardware and/or software components configured to obtain data, store data, provide data to other entities, and/or to perform any other task to facilitate performance of the computer-implemented services.

All, or a portion, of data sources 100 may provide (and/or participate in and/or support the) computer-implemented services to various computing devices operably connected to data sources 100. Different data sources may provide similar and/or different computer-implemented services.

For example, data sources 100 may include demand data regarding demand for a product. The demand data may include (i) historical data regarding demand for the product, (ii) historical data regarding consumer spending, (iii) forecasted data regarding market trends (e.g., which may impact demand for the product), (iv) data regarding the consumer, and/or (v) other demand data.

Additionally, data sources 100 may include supply data regarding supply of a product. The supply data may include (i) historical data regarding market availability of the product (e.g., from any number of suppliers), (ii) historical data regarding supply of the product from a supplier, (iii) historical data regarding the likelihood of fulfillment of a contract for a product with the supplier, (iv) forecasted data regarding market trends, (v) data regarding the supplier, and/or (iv) other supply data.

Data sources 100 may provide the data (e.g., the supply data, the demand data) to contract manager 104. A user of contract manager 104 may be responsible for using the data to make and/or modify contracts with suppliers of products. For example, a user of contract manager 104 may be a business decision maker within a company tasked with using the data from data sources 100 to determine whether a contract with a supplier will provide enough product to the company to meet the needs of the company for the product.

For example, the company may sell computers. To sell the computers, the company may have a contract with a supplier for a material needed to build the computer (e.g., a hard drive). A user of contract manager 104 may be tasked with determining whether the contract the company has with the supplier of hard drives will provide a sufficient quantity of hard drives to meet the needs of the company for hard drives.

To make the determination, contract manager 104 may compare between the supply data and the demand data from data sources 100. Continuing the above example, contract manager 104 may compare between supply data for hard drives and demand data for computers to determine whether the contract with the supplier of hard drives will provide enough hard drives for the company to meet the demand for computers.

The user of contract manager 104 may determine that there is a risk the contract with the supplier may not provide the company with a sufficient quantity of products to meet the needs of the company. To mitigate the risk, the user of contract manager 104 may decide to update the contract. For example, the user of contract manager 104 may decide to add an options clause to the contract, the options clause indicating an additional quantity of products to be provided by the supplier if the company exercises the options clause. The company may not exercise the options clause if they do not require additional products from the supplier.

While determining whether to update the contract, the user of contract manager 104 may consume resources inefficiently resulting in incurred expenses for the company, the resources may include: (i) the user's time, (ii) the user's cognitive resources, (iii) computing resources consumed while the user manually analyzes the data using a computer, and/or (iv) other resources.

Additionally, because the user of contract manager 104 may make a qualitative assessment regarding whether there is a need to update the contract and may manually input information reflective of the qualitative assessment into contract manager 104 during contract generation, the user may make an error. The error may include: (i) incorrectly interpreting supply and/or demand data, (ii) incorrectly determining the company's need for the product, (iii) incorrectly inputting the information into the contract manager 104 and/or (iv) other errors. As a result of the error, the company may not be able to meet consumer demand for their products and/or may purchase too many products from suppliers, resulting in loss of revenue.

In general, embodiments disclosed herein may provide methods, systems, and/or devices for managing contracts. To manage contracts, the system may use a first inference model to generate demand predictions and a second inference model to generate supply predictions for a product. The supply predictions may be combined to obtain an aggregated supply prediction and the demand predictions may be combined to obtain an aggregated demand prediction.

The aggregated supply prediction may then be compared to the aggregated demand prediction in order to obtain a difference between them, representing the quantity of products needed for supply to meet demand, and an uncertainty value associated with the difference. The difference may then be compared to acceptability criteria to determine whether the addition of an options clause to the contract is necessary.

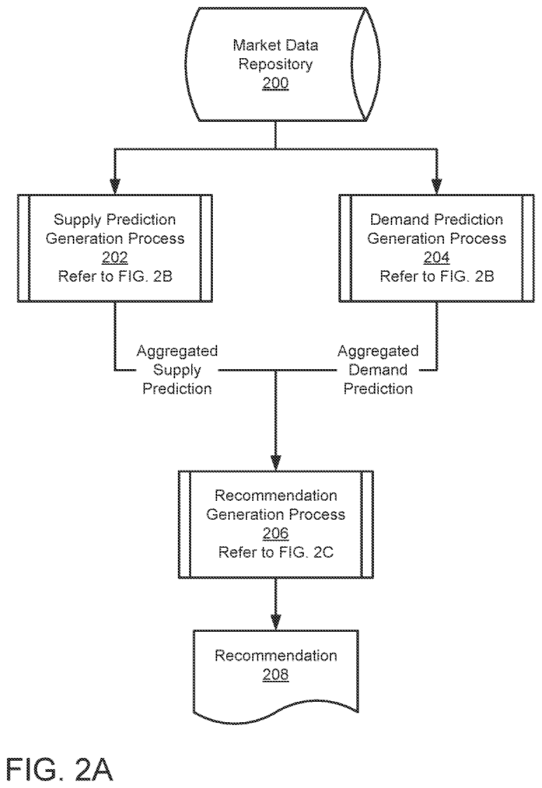

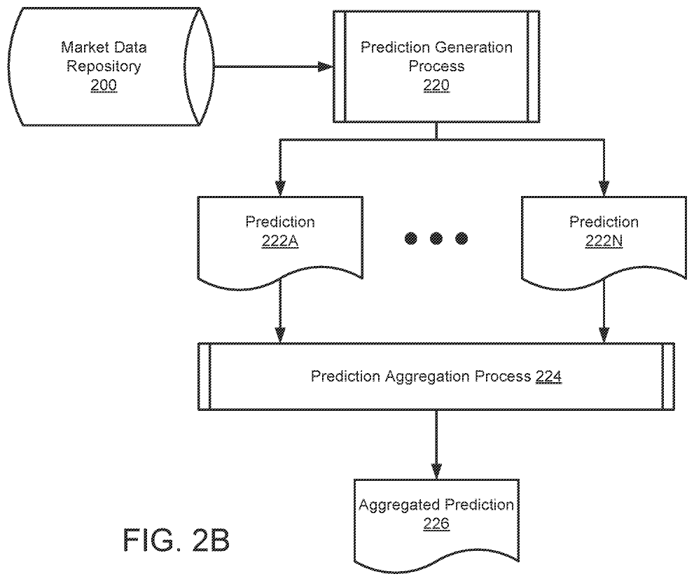

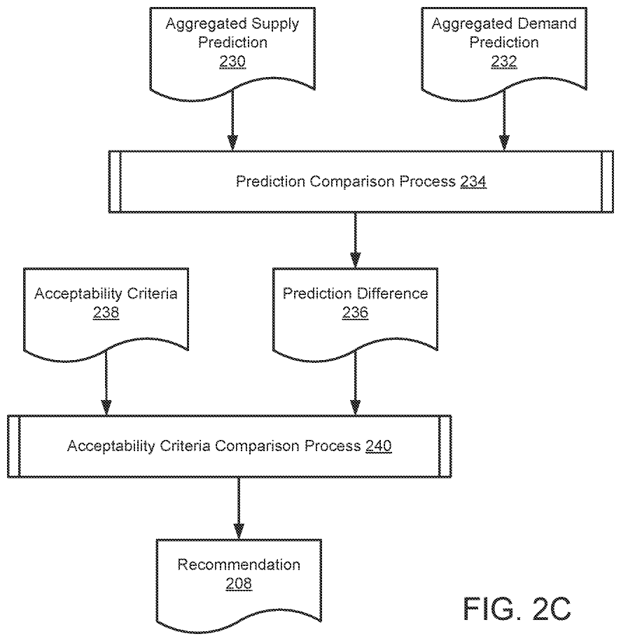

If the acceptability criteria are not met, it may be recommended that the contract be updated with an options clause to include a quantity of products needed to hedge against the uncertainty to reduce the likelihood of the quantity of products in the contract not meeting product demand. Refer to FIG. 2C for additional details regarding the options clause.

By doing so, a system in accordance with an embodiment may be more likely to accurately predict the available supply of a product by taking into account the aggregated supply from all suppliers, and the demand for a product by taking into account the aggregated demand from all consumers of the product. As a result, a system in accordance with an embodiment may be more likely to accurately calculate the difference and uncertainty between supply and demand for a product by making a quantitative assessment regarding the addition of an options clause to a contract, resulting in a higher likelihood that the options clause will be appropriately recommended to be added to a contract for the correct quantity of products. In addition to reducing sources of error in the calculations, automating contract recommendation generation using computer-implemented methods may also reduce resource consumption, further reducing overall costs regarding contract management.

To perform the above-noted functionality, the system of FIG. 1 may include data sources 100, inference model manager 102, and/or contract manager 104. Each of these components is discussed below.

Data sources 100 may include data from any number of sources (data sources 100A-100N), and may provide data to inference model manager 102. Inference model manager 102 may include any number and/or type of data processing systems. The data processing systems may host any number and/or type of inference models trained to generate inferences (e.g., predictions).

Inference model manager 102 may provide inference model management services. To provide the inference model management services, inference model manager 102 may obtain data (e.g., from data sources 100), process the data (e.g., fill data gaps, transform the data, extract values from the data), generate predictions (e.g. using the data as input for the inference models), analyze the predictions (e.g., make comparisons between predictions) and/or may provide the predictions to other entities (e.g., contract manager 104) as part of facilitating the computer-implemented services.

Contract manager 104 may utilize the predictions and/or analyses obtained by inference model manager 102 to assist with managing contracts. For example, a user of contract manager 104 may use the predictions generated by inference model manager 102 to determine whether a contract with a supplier should be updated.

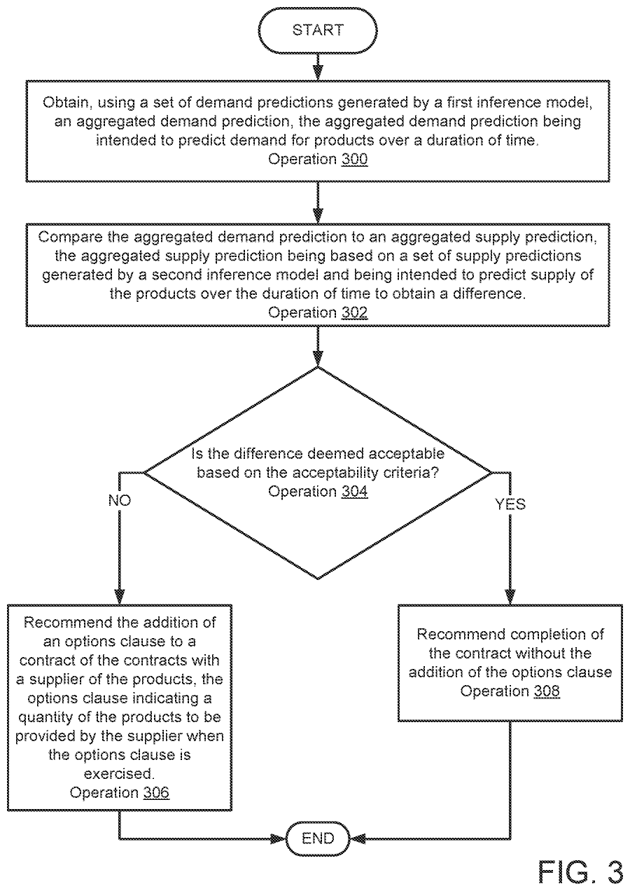

When providing their functionality, any of data sources 100, inference model manager 102, and contract manager 104 may perform all, or a portion, of the processes, interactions, and methods illustrated in FIGS. 2A-3.

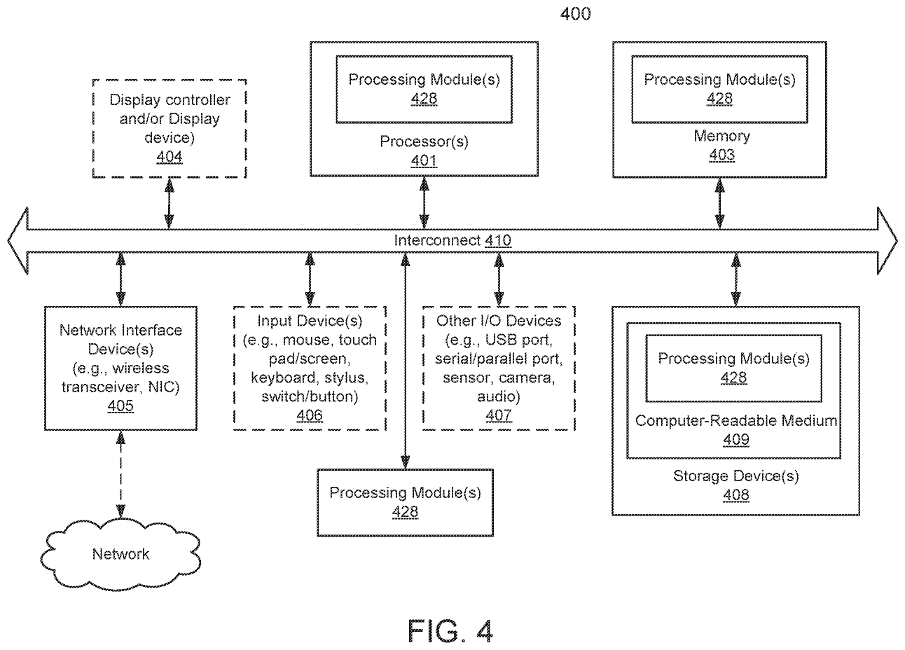

Any of data sources 100, inference model manager 102, and contract manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 208, 226, etc.) is used to represent data structures, a second set of shapes (e.g., 202, 204, etc.) is used to represent processes performed using and/or that generate data, and a third set of shapes (e.g., 200, etc.) is used to represent large scale data structures such as databases.

Turning to FIG. 2A, a first data flow diagram in accordance with an embodiment is shown. The first data flow diagram may illustrate data used in and data processing performed in generating a contract recommendation.

To generate a contract recommendation, supply prediction generation process 202 and demand prediction generation process 204 may be performed using data from market data repository 200. Market data repository 200 may include data from any number of data sources, and may include data regarding: (i) product supply, (ii) product demand, and/or (iii) other data.

During demand prediction generation process 204, demand data from market data repository 200 may be ingested by a first inference model to generate any number of demand predictions (not shown). The demand predictions may be used to generate an aggregated demand prediction, which may be intended to predict product demand over a duration of time. During supply prediction generation process 202, supply data from market data repository 200 may be ingested by a second inference model to generate any number of supply predictions (not shown). The supply predictions may be used to generate an aggregated supply prediction, which may be intended to predict product supply over a duration of time. Refer to FIG. 2B for additional details regarding supply prediction generation process 202 and demand prediction generation process 204.

The aggregated supply prediction and the aggregated demand prediction may then be used to perform recommendation generation process 206. To perform recommendation generation process 206, the aggregated supply prediction and the aggregated demand prediction may be analyzed, and the output of the analysis may be compared to acceptability criteria. Recommendation 208 may then be generated based on the comparison to the acceptability criteria. Refer to FIG. 2C for additional details regarding recommendation generation process 206.

Recommendation 208 may then be provided to contract manager 104 shown in FIG. 1. Recommendation 208 may include (i) a recommendation to add an options clause to a contract with a supplier, (ii) a recommendation for a quantity of products to be added to the options clause, (iii) a recommendation not to add an options clause to the contract, and/or (iv) other recommendations.

Thus, by implementing the data flow shown in FIG. 2A, a system in accordance with embodiments disclosed herein may be more likely to provide a recommendation for a contract with a supplier regarding the addition of an options clause to the contract that accurately predicts if and how many additional products may be needed for supply to meet demand.

Turning to FIG. 2B, a second data flow diagram in accordance with an embodiment is shown. The second data flow diagram may illustrate data used in and data processing performed in generating an aggregated supply prediction and/or an aggregated demand prediction to be used to generate a contract recommendation. FIG. 2B may be an expansion of supply prediction generation process 202 and demand prediction generation process 204 shown in FIG. 2A.

To generate an aggregated supply prediction and/or an aggregated demand prediction, prediction generation process 220 may be performed. To perform prediction generation process 220, relevant data (e.g., demand data, supply data) may be obtained from market data repository 200 to generate predictions.

To generate the predictions, prediction generation process 220 may use an inference model. The inference model may use the relevant data as input to generate a set of predictions (e.g., prediction 222A-222N).

For example, a first inference model may be used to generate a set of demand predictions. The first inference model may be a neural network trained using first training data to predict product demand. To generate the set of demand predictions, the first inference model may ingest demand data from market data repository 200 regarding the demand for a product. The demand data may include: (i) historical data regarding demand for a product, (ii) historical data regarding consumer spending, and/or (iii) other data.

The first inference model may generate a set of demand predictions as output from the inference model, the set of demand predictions including a list that specifies internal consumers and sub-demand for each of the internal consumers. Internal consumers may include business divisions within the company which consume the product sold by the supplier (e.g., hard drives, monitors).

For example, a company may purchase hard drives from a supplier and may distribute the purchased hard drives to any number of internal consumers to use as a component in the products sold by the company. The internal consumers may include all of the business divisions within the company that produce products which consume a hard drive (e.g., a first business division responsible for building laptop computers, a second business division responsible for building desktop computers).

A first internal consumer may be associated with a first sub-demand (e.g., a number of hard drives needed by the first business division) and a second internal consumer may be associated with a second sub-demand (e.g., a number of hard drives needed by the second business division). The set of demand predictions may, therefore, include a list specifying sub-demand for each of the internal consumers.

For example, the company may use a first inference model to generate a set of demand predictions including: (i) a prediction regarding the demand for hard drives by the first business division (e.g., prediction 222A) and (ii) a prediction regarding the demand for hard drives by the second business division (e.g., prediction 222B).

Prediction generation process 220 may also include a second inference model to generate a set of supply predictions. The second inference model may be a neural network trained using second training data to predict product supply. To generate the set of supply predictions, the inference model may ingest supply data from market data repository 200 regarding the supply of a product. The supply data may include: (i) historical data regarding market availability of the product, (ii) historical data regarding supply of the product from a supplier, (iii) historical data regarding a likelihood of contract fulfillment by a supplier, and/or (iv) other data. The second inference model may generate a set of supply predictions as output from the inference model, the set of supply predictions including a list that specifies suppliers and sub-supply for each of the suppliers (e.g., the supply of the product from each of the suppliers).

Continuing with the above example, the company that sells computers may obtain hard drives from any number of suppliers. The company may use a second inference model to generate a set of supply predictions including: (i) a prediction regarding the supply of hard drives from a first supplier (prediction 222C) and (ii) a prediction regarding the supply of hard drives from a second supplier (prediction 222D).

After prediction generation process 220, prediction aggregation process 224 may be performed. To perform prediction aggregation process 224, generated predictions (e.g., the set of demand predictions, the set of supply predictions) may be combined to obtain an aggregated prediction 226 (e.g., an aggregated demand prediction, an aggregated supply prediction).

The aggregated demand prediction may be a sum of the sub-demand for each of the internal consumers, representing the total demand for the product obtained from the supplier. For example, the aggregated demand prediction for hard drives may include a sum of the sub-demand for hard drives (e.g., a total demand for hard drives across all internal consumers).

Continuing with the above example, the company may be reviewing a contract for hard drives to determine whether the current contract will provide a sufficient quantity of hard drives to allow the company to meet demand for computers containing hard drives (e.g., laptop computers and desktop computers). To assess demand for hard drives, the predictions regarding the demand for computers containing hard drives may be combined (e.g., prediction 222A and prediction 222B) to obtain an aggregated demand prediction for hard drives.

Similarly, to assess supply of hard drives, the predictions regarding the supply of hard drives from the suppliers may be combined (e.g., prediction 222C and prediction 222D) to obtain an aggregated supply prediction for hard drives. The aggregated supply prediction may be a sum of the sub-supply for each of the suppliers. For example, the aggregated supply prediction for hard drives may be a sum of the sub-supply for hard drives (e.g., supply of hard drives from each of the suppliers).

Thus, via the processes illustrated in FIG. 2B, a system in accordance with an embodiment may generate an aggregated supply and/or an aggregated demand prediction. By combining individual predictions to obtain an aggregated prediction, the total supply and total demand for a product can be compared, which may increase the likelihood of accurately calculating the difference between the supply and the demand of a product used to make contract recommendations.

Turning to FIG. 2C, a third data flow diagram in accordance with an embodiment is shown. The third data flow diagram may illustrate data used in and data processing performed in comparing the aggregated supply prediction to the aggregated demand prediction to generate a contract recommendation. FIG. 2C may be an expansion of recommendation generation process 206 shown in FIG. 2A.

To compare aggregated supply prediction 230 to aggregated demand prediction 232, prediction comparison process 234 may be performed. During prediction comparison process 234, aggregated supply prediction 230 and aggregated demand prediction 232 may be analyzed to generate a difference (e.g., prediction difference 236). Prediction difference 236 may indicate a quantity of products needed for product supply to meet product demand over a duration of time, as well as a level of uncertainty in the quantity.

For example, if the aggregated supply prediction for a product is less than the aggregated demand prediction for a product, the prediction difference may indicate the quantity of products needed for the product supply to meet product demand. The prediction difference may also indicate a level of uncertainty in the quantity. For example, when calculating the quantity of products needed for product supply to meet product demand, there may be an error associated with the quantity.

After the generation of prediction difference 236, acceptability criteria comparison process 240 may be performed. To perform acceptability criteria comparison process 240, prediction difference 236 may be compared to acceptability criteria 238. Acceptability criteria 238 may indicate an uncertainty in the difference between supply and demand that is acceptable for the company to continue with the existing contract.

For example, acceptability criteria 238 may indicate a value of the uncertainty in the difference at or below which the addition of an options clause to a contract for a product is not recommended, the options clause indicating a quantity of products to be provided by the supplier when the options clause is exercised. If prediction difference 236 indicates a value above acceptability criteria 238, the addition of an options clause to the contract for a product may be recommended.

By performing acceptability criteria comparison process 240, recommendation 208 may be generated. Refer to FIG. 2A for additional details regarding recommendation 208.

If recommendation 208 recommends the addition of an options clause to the contract, it may indicate the quantity of products needed to hedge against the uncertainty to reduce the likelihood of the quantity of products provided by the supplier in the contract not meeting the product demand.

For example, if the addition of an options clause is recommended, it may recommend the addition of the quantity of products needed to equal the maximum value of the uncertainty in the difference between the aggregated demand prediction and the aggregated supply prediction. The uncertainty value may represent the probability that the quantity of products provided by the supplier in the contract is not sufficient to meet product demand. An increase in the level of uncertainty in the quantity of products needed for the supply of the product to meet the demand for the product may indicate an increase in a probability that the quantity of the products provided by the supplier according to the contract will not be sufficient to allow product supply to meet product demand.

For example, the uncertainty value may represent the error in the calculation of the quantity of products needed for product supply to meet product demand. In order to increase a likelihood that product supply will meet product demand, the options clause may include the quantity of products needed to meet the maximum quantity of products indicated by the error.

For example, the quantity of hard drives needed by the company to meet demand for computers containing hard drives may be calculated to be 100±10 hard drives (e.g., the quantity of hard drives needed for hard drive supply to meet hard drive demand plus or minus the error). To reduce the risk that the company has an insufficient quantity of hard drives, the company may include 10 hard drives in the options clause (e.g., the quantity of hard drives needed to equal the maximum quantity indicated by the error).

While described above with respect to an options clause including additional product to be provided by the supplier when the options clause is exercised, it will be appreciated that the options clause may include a reduction in the quantity of products to be provided by the supplier without departing from embodiments disclosed herein. Such an options clause may allow for an uncertainty indicating lower than expected demand to be hedged against.

If the addition of an options clause to the contract is recommended, the options clause may be generated using a rule set for options clause generation. The rule set may include rules keyed to the level of the uncertainty in the quantity.

For example, the rule set may include rules based on (i) product supply needs of the company (e.g., rules for the addition of an options clause indicating a quantity of products based on the type of product), (ii) risk tolerance of the company (e.g., the percentage of products indicated by the level of uncertainty to include in the options clause), (iii) cost optimization (e.g., optimizing the price per product among multiple suppliers), and/or (iv) other needs. For example, a company with a high risk tolerance may choose to include a quantity of products in the options clause to meet the maximum level of uncertainty in the difference indicated by the aggregated supply and aggregated demand predictions, while a company with a low risk tolerance may choose to include only a portion of the quantity of products indicated by the difference.

Thus, via the processes illustrated in FIG. 2C, a system in accordance with an embodiment may use an aggregated supply prediction and an aggregated demand prediction to generate a contract recommendation. By comparing the aggregated supply prediction to the aggregated demand prediction to obtain a difference and uncertainty in the difference, it may increase a likelihood that an accurate and quantitative recommendation be made regarding the addition of an options clause to a contract including the quantity of products to include in the options clause. The use of the uncertainty value to determine the quantity of products to add to the options clause may further reduce the likelihood that the supply of the product does not meet demand.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2C may perform various methods to manage contract recommendations. FIG. 3 illustrates a method that may be performed by the components of the system of FIGS. 1-2C. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing contracts in accordance with an embodiment is shown. The method may be performed, for example, by any of the components of the system of FIG. 1, and/or any other entity without departing from embodiments disclosed herein.

At operation 300, an aggregated demand prediction may be obtained using a set of demand predictions generated by a first inference model to predict demand for products over a duration of time.

Obtaining the aggregated demand prediction may include (i) obtaining demand data (e.g., reading the demand data from storage, receiving the demand data from another device), (ii) obtaining a set of demand predictions using a first inference model (e.g., generating the set of demand predictions using a neural network using the demand data as ingest for the neural network, receiving the set of demand predictions from another device), (iii) aggregating the set of demand predictions to obtain the aggregated demand prediction (e.g., combining the set of demand predictions to account for the total product demand, providing the set of demand predictions to another entity responsible for aggregating the set of demand predictions), and/or (iv) via other methods.

At operation 302, the aggregated demand prediction may be compared to an aggregated supply prediction to obtain a difference. The aggregated supply prediction may be based on a set of supply predictions generated by a second inference model and may be intended to predict supply of the products over the duration of time.

Obtaining the aggregated supply prediction may include (i) obtaining supply data (e.g., reading the supply data from storage, receiving the supply data from another device), (ii) obtaining a set of supply predictions using a second inference model (e.g., generating the set of supply predictions using a neural network using the supply data as ingest for the neural network, receiving the set of supply predictions from another device), (iii) aggregating the set of supply predictions to obtain the aggregated supply prediction (e.g., combining the set of supply predictions to account for the total product supply, providing the set of supply predictions to another entity responsible for aggregating the set of supply predictions), and/or (iv) via other methods.

Comparing the aggregated demand prediction to the aggregated supply prediction may include subtracting the quantity of products indicated by the aggregated supply prediction from the quantity of products indicated by the aggregated demand prediction to obtain a difference indicating the quantity of products needed for supply to meet demand, and/or other methods.

Obtaining a difference may include obtaining an uncertainty in the difference, the uncertainty in the difference may include: (i) generating the uncertainty based on an uncertainty in the aggregated demand prediction and an uncertainty in the aggregated supply prediction, (ii) providing the aggregated supply prediction and the aggregated demand prediction to another entity responsible for generating the uncertainty in the difference, and/or (iii) other methods.

At operation 304, it may be determined whether the difference is deemed acceptable based on the acceptability criteria. For example, the determination may be made by obtaining the acceptability criteria and analyzing the difference to ascertain whether it meets the acceptability criteria. Obtaining the acceptability criteria may include: (i) reading the acceptability criteria from storage, (ii) generating the acceptability criteria based on the needs of the company, (iii) receiving the acceptability criteria from another device, and/or (iv) via other methods. Analyzing the difference to ascertain whether it meets the acceptability criteria may include: (i) comparing a quantity of the difference to a quantity indicated by the criteria, (ii) providing the difference and the acceptability criteria to another entity responsible for comparing the difference to the acceptability criteria and receiving a report as a response, the report indicating whether the difference is acceptable, and/or (iii) other methods.

If it is determined that the difference is not deemed to be acceptable based on the acceptability criteria (e.g., the determination is “No” at operation 304), then the method may proceed to operation 306.

At operation 306, the addition of an options clause to a contract of the contracts with a supplier of the suppliers may be recommended. The options clause may indicate a quantity of the products to be provided by the supplier when the options clause is exercised. Recommending the addition of an options clause may include generating the options clause using a rule set for options clause generation.

Generating the options clause using a rule set for options clause generation may include: (i) obtaining a rule set for options clause generation, (ii) parsing the rule set for options clause generation to determine which rules apply, (iii) selecting a rule from the rule set for options clause generation, and/or (iv) other methods.

The method may end following operation 306.

Returning to operation 304, if it is determined that the difference is deemed to be acceptable based on the acceptability criteria (e.g., the determination is “Yes” at operation 304), then the method may proceed to operation 308.

At operation 308, the completion of the contract without the addition of the options clause may be recommended. Recommending the contract be completed without the addition of the options clause may include not making any changes to the contract based on the difference between the aggregated supply prediction and the aggregated demand prediction.

The method may end following operation 308.

Thus, using the methods illustrated in FIG. 3, embodiments disclosed herein may provide systems and methods usable to manage contract recommendations with suppliers of products to increase the likelihood that product supply meets product demand by determining whether to add an options clause to the contract and the quantity of additional products to be included in the options clause.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing contracts, the method comprising:
obtaining, using a set of demand predictions generated by a first inference model, an aggregated demand prediction, the aggregated demand prediction being intended to predict demand for products over a duration of time;
comparing the aggregated demand prediction to an aggregated supply prediction, the aggregated supply prediction being based on a set of supply predictions generated by a second inference model and being intended to predict supply of the products over the duration of time to obtain a difference;
making a determination, using at least a portion of the difference and acceptability criteria, regarding whether the difference is deemed to be acceptable based on the acceptability criteria;
in a first instance of the determination in which the difference is not deemed to be acceptable based on the acceptability criteria:
recommending addition of an options clause to a contract of the contracts with a supplier of the products, the options clause indicating a quantity of the products to be provided by the supplier when the options clause is exercised; and
in a second instance of the determination in which the difference is deemed to be acceptable based on the acceptability criteria:
recommending completion of the contract without the addition of the options clause.

2. The method of claim 1, wherein obtaining the aggregated demand prediction comprises:
obtaining demand data;
obtaining, using the first inference model and the demand data, the set of demand predictions; and
aggregating the set of demand predictions to obtain the aggregated demand prediction.

3. The method of claim 2, wherein the set of demand predictions is stored as a list that specifies internal consumers and sub-demand for each of the internal consumers, and the aggregate demand prediction comprises:
a sum of the sub-demand for each of the internal consumers; and
a level of uncertainty in the sum of the sub-demand for each of the internal consumers.

4. The method of claim 2, wherein obtaining the aggregated supply prediction comprises:
obtaining supply data;
obtaining, using the second inference model and the supply data, the set of supply predictions; and
aggregating the set of supply predictions to obtain the aggregated supply prediction.

5. The method of claim 4, wherein the difference comprises:
a quantity of products needed for product supply to meet product demand over the duration of time; and
a level of uncertainty in the quantity of products needed for the supply of the product to meet the demand for the product over the duration of time.

6. The method of claim 5, wherein the options clause comprises:
a quantity of products, the quantity comprising:
the quantity of products needed to hedge against the uncertainty to reduce a likelihood of the quantity of products not meeting the product demand.

7. The method of claim 5, further comprising:
in the first instance of the determination in which the difference is deemed to be acceptable based on the acceptability criteria and prior to making the recommendation for addition of the options clause:
generating the options clause using a rule set for options clause generation.

8. The method of claim 7, wherein the rule set for options clause generation comprises rules keyed to the level of the uncertainty in the quantity of the products needed for the supply of the product to meet the demand for the product over the duration of time.

9. The method of claim 1, wherein the first inference model is a neural network trained using first training data to predict product demand, and the second inference model is a neural network trained using second training data to predict product supply.

10. The method of claim 4, wherein the set of supply predictions is stored as a list that specifies suppliers and sub-supply for each of the suppliers, and the aggregated supply prediction comprises:
a sum of the sub-supply for each of the suppliers; and
a level of uncertainty in the sum of the sub-supply for each of the suppliers.

11. The method of claim 2, wherein the demand data comprises at least one type of data selected from a group consisting of:
historical data regarding demand for the products; and
historical data regarding consumer spending.

12. The method of claim 4, wherein the supply data comprises at least one type of data selected from a group consisting of:
historical data regarding market availability of the products;
historical data regarding supply of the products from a supplier of the suppliers; and
historical data regarding a likelihood of contract fulfillment by a supplier of the suppliers.

13. The method of claim 5, wherein an increase in the level of uncertainty in the quantity of products needed for the supply of the product to meet the demand for the product indicates an increase in a probability that a quantity of the products provided by the supplier according to the contract will not be sufficient to allow product supply to meet product demand.

14. A non-transitory machine-readable medium having instructions stored therein, which when executed by a processor, cause the processor to perform operations for managing contracts, the operations comprising:
obtaining, using a set of demand predictions generated by a first inference model, an aggregated demand prediction, the aggregated demand prediction being intended to predict demand for products over a duration of time;
comparing the aggregated demand prediction to an aggregated supply prediction, the aggregated supply prediction being based on a set of supply predictions generated by a second inference model and being intended to predict supply of the products over the duration of time to obtain a difference;
making a determination, using at least a portion of the difference and acceptability criteria, regarding whether the difference is deemed to be acceptable based on the acceptability criteria;
in a first instance of the determination in which the difference is not deemed to be acceptable based on the acceptability criteria:
recommending addition of an options clause to a contract of the contracts with a supplier of the products, the options clause indicating a quantity of the products to be provided by the supplier when the options clause is exercised; and
in a second instance of the determination in which the difference is deemed to be acceptable based on the acceptability criteria:
recommending completion of the contract without the addition of the options clause.

15. The non-transitory machine-readable medium of claim 14, wherein obtaining the aggregated demand prediction comprises:
obtaining demand data;
obtaining, using the first inference model and the demand data, the set of demand predictions; and
aggregating the set of demand predictions to obtain the aggregated demand prediction.

16. The non-transitory machine-readable medium of claim 15, wherein the set of demand predictions is stored as a list that specifies internal consumers and sub-demand for each of the internal consumers, and the aggregate demand prediction comprises:
a sum of the sub-demand for each of the internal consumers; and
a level of uncertainty in the sum of the sub-demand for each of the internal consumers.

17. The non-transitory machine-readable medium of claim 15, wherein obtaining the aggregated supply prediction comprises:
obtaining supply data;
obtaining, using the second inference model and the supply data, the set of supply predictions; and
aggregating the set of supply predictions to obtain the aggregated supply prediction.

18. A data processing system, comprising:
a processor; and
a memory coupled to the processor to store instructions, which when executed by the processor, cause the processor to perform operations for managing contracts, the operations comprising:
obtaining, using a set of demand predictions generated by a first inference model, an aggregated demand prediction, the aggregated demand prediction being intended to predict demand for products over a duration of time;
comparing the aggregated demand prediction to an aggregated supply prediction, the aggregated supply prediction being based on a set of supply predictions generated by a second inference model and being intended to predict supply of the products over the duration of time to obtain a difference;
making a determination, using at least a portion of the difference and acceptability criteria, regarding whether the difference is deemed to be acceptable based on the acceptability criteria;
in a first instance of the determination in which the difference is not deemed to be acceptable based on the acceptability criteria:
recommending addition of an options clause to a contract of the contracts with a supplier of the products, the options clause indicating a quantity of the products to be provided by the supplier when the options clause is exercised; and
in a second instance of the determination in which the difference is deemed to be acceptable based on the acceptability criteria:
recommending completion of the contract without the addition of the options clause.

19. The data processing system of claim 18, wherein obtaining the aggregated demand prediction comprises:
obtaining demand data;
obtaining, using the first inference model and the demand data, the set of demand predictions; and
aggregating the set of demand predictions to obtain the aggregated demand prediction.

20. The data processing system of claim 19, wherein the set of demand predictions is stored as a list that specifies internal consumers and sub-demand for each of the internal consumers, and the aggregate demand prediction comprises:
a sum of the sub-demand for each of the internal consumers; and
a level of uncertainty in the sum of the sub-demand for each of the internal consumers.
